(19) United States
(12) Patent Application Publication
(10) Pub. No.: US 2009/0037886 A1
(43) Pub. Date: Feb. 5, 2009

(54) APPARATUS AND METHOD FOR EVALUATING A FREE-RUNNING TRACE STREAM

(75) Inventors: Scott M. MCCOY, Scappoose, OR (US); Ernest L. EDGAR, Larkspur, CO (US); Bruce J. ABLEIDINGER, Portland, OR (US)

Correspondence Address: MIPS c/o COOLEY GODWARD KRONISH LLP, 777 6TH STREET NW SUITE 1100, ATTN: PATENT GROUP / WSG-PA, WASHINGTON, DC, 20001, US

(73) Assignee: MIPS TECHNOLOGIES, INC., Mountain View, CA (US)

(21) Appl. No.: 11/830,795

(22) Filed: Jul. 30, 2007

(51) Int. Cl. G06F 9/44

(52) U.S. Cl. 717/128

(57) ABSTRACT

A system includes a processor to generate a free-running trace stream and a probe with a real-time decoder to dynamically detect a trigger included in the free-running trace stream.

### BRIEF DESCRIPTION OF THE INVENTION

This invention relates generally to debugging digital systems. More particularly, this invention relates to an off-chip probe for continuous non-intrusive real-time trace decoding.

### BACKGROUND OF THE INVENTION

PDTrace refers to a set of digital system debugging tools available through MIPS Technologies, Inc., Mountain View, Calif. The PDTrace technology is described in U.S. Pat. Nos. 7,231,551; 7,178,133; 7,055,070; and 7,043,668, the contents of which are incorporated herein by reference.

Current PDTrace probes may not be able to accumulate a comprehensive amount of off-chip trace information. The only off-chip PDTrace information that is stored in the probe is stored in a circular trace buffer. Therefore, the trace information is frequently overwritten and does not provide comprehensive free-running PDTrace information. In the event of a core stall, the probe no longer receives real-time information. For example, PDTrace supports a trace-bandwidth-limit induced backstall, which is a type of core stall to prevent trace-bandwidth overflow and a subsequent loss of trace synchronization. This technique allows for continuous trace reconstruction, but does so at the cost of altering the target's execution timing.

Ordinarily, PDTrace compresses the PC address and does not indicate certain types of branches at all (e.g., unconditional branches with a known destination address). For execution profiling or code coverage, the analysis system must connect to the system at the internal execution pipeline, not the external processor bus. The bus typically has instruction fetches that are never executed due to prefetching and would not have a fetch for every instruction execution due to the on-chip cache. Some coverage or profiling tools connect to the external buses and therefore cannot render a completely accurate result when processing execution flow.

In view of the foregoing, it would be desirable to provide an off-chip probe that connects to an external bus, yet provides accurate trace information despite processor stalls and trace buffer overflow.

### SUMMARY OF THE INVENTION

The invention includes a system with a processor to generate a free-running trace stream and a probe with a real-time decoder to dynamically detect a trigger included in the free-running trace stream.

The invention also includes a probe with a trace memory. A real-time decoder generates a supplemental trace stream in response to a trace stream overwriting the trace memory. An indictor is responsive to the supplemental trace stream to provide a real-time indication of an execution state within a processor.

The invention also includes a method of monitoring a trace stream from a processor. A supplemental trace stream is generated in response to a specified condition. A real-time event indicator is activated in response to a selected processor event evidenced in the supplemental trace stream.

The invention also includes a computer readable storage medium with executable instructions to specify a probe with a real-time decoder to dynamically detect a trigger included in a free-running trace stream generated by a processor. An event indicator provides a real-time indication of an execution state within the processor.

Thus, the invention provides continuous real-time decoding of trace information. The probe takes various actions based upon the decoded trace information. The invention supports the accumulation of trace information, even when trace buffer information is overwritten on the probe.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a histogram of real-time processor execution information constructed in accordance with an embodiment of the invention.

FIG. 4 illustrates a code coverage table processed in accordance with an embodiment of the invention.

Like reference numerals refer to corresponding parts throughout the several views of the drawings.

### DETAILED DESCRIPTION OF THE INVENTION

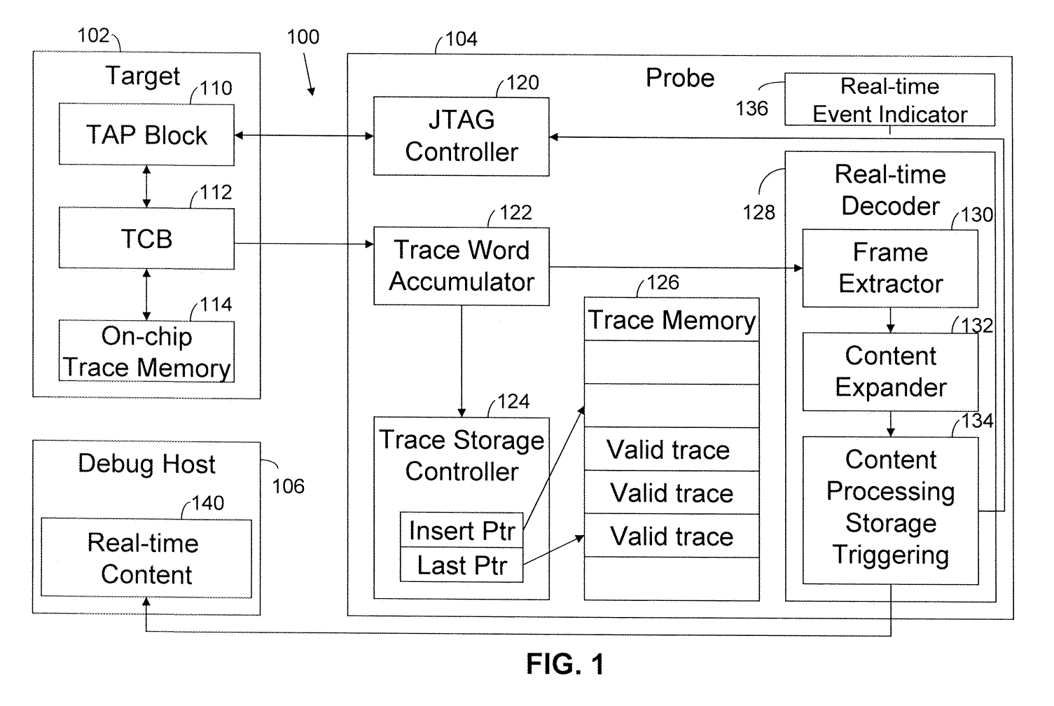

FIG. 1 illustrates a system 100 configured in accordance with an embodiment of the invention. The system 100 includes a processor or target 102, which communicates with an off-chip probe 104. The off-chip probe 104 may communicate with a debug host 106. The debug host 106 may be a computer that is configured to log and process free-running trace stream information. For example, the processing may be in the form of providing time averaged data of real-time processor execution state information.

In one embodiment, the processor 102 includes a test access port (TAP) control block 110. A trace control block (TCB) 112 communicates with the TAP block 110 and on-chip trace memory 114. A processor core (not shown) generates trace information that is processed by the TCB 112. By way of example, the processor 102 may generate PDTrace information, which is an extension of the EJTAG debug architecture. As is known in the art, EJTAG is a proprietary extension of the widely used IEEE JTAG pins (IEEE 1149.1) supported by MIPS Technologies, Inc., the assignee of the present application. The on-chip trace memory 114 stores trace information in accordance with known techniques. For example, it is possible to choose between an on-chip or off-chip trace buffer.

The probe 104 includes a Joint Test Access Group (JTAG) controller 120, which communicates with the TAP block 110, utilizing known techniques. A trace word accumulator 122 communicates with the TCB 112 and applies trace information to a trace storage controller 124. The trace storage controller 124 writes trace information to a trace memory 126. Trace memory 126 is a circular buffer and therefore the trace information is regularly overwritten. The trace storage controller 124 may utilize pointers (e.g., an insert pointer and a last pointer) to write valid trace information to the trace memory 126.

The components of system 100 discussed up to this point are known. The invention is directed toward the utilization of a real-time decoder 128 within the probe 104 to dynamically detect a trigger included in a free-running trace stream. The free-running trace stream originates at the processor 102 and is passed by the trace word accumulator 122 to the real-time decoder 128. In one implementation, the real-time decoder includes a frame extractor 130. The frame extractor 130 is configured to identify frame borders, the frame length and frame type in the free-running trace stream.

The frame extractor is connected to a content expander 132. The content expander 132 identifies events (e.g., overflow, stall, back-stall, flush, execution) associated with a frame. The content expander 132 may be configured to decompress trace data. The content expander passes identified events to a content processing and storage triggering module 134. This module 134 processes identified events. For example, in one embodiment, the module 134 is configured to compare an identified event to one or more specified events, which may be a set of user trace words, detection of a user specified address or addresses, an indication of addresses completed, the number of cycles, backstalls, bandwidth overflows or other selected indicators. For example, the module 134 may be configured to identify PDTrace overflow (IO==0) or PDTrace backstall (IO==1). When such an event is identified, the module 134 may log the trace information by passing the real-time content 140 to the debug host 106. The trace information may include user trace words and the address. The trace information may be concurrently passed to debug host 106 or transferred only when bandwidth is available.

The module 134 is also connected to a real-time event indicator 136 (e.g., a light emitting diode (LED)) on the probe. The real-time event indicator provides information regarding a selected event. For example, the real-time event indicator may be used to identify high bandwidth regions of a large code base. In the event of a real-time indication, the user may alter the amount of information that is traced.

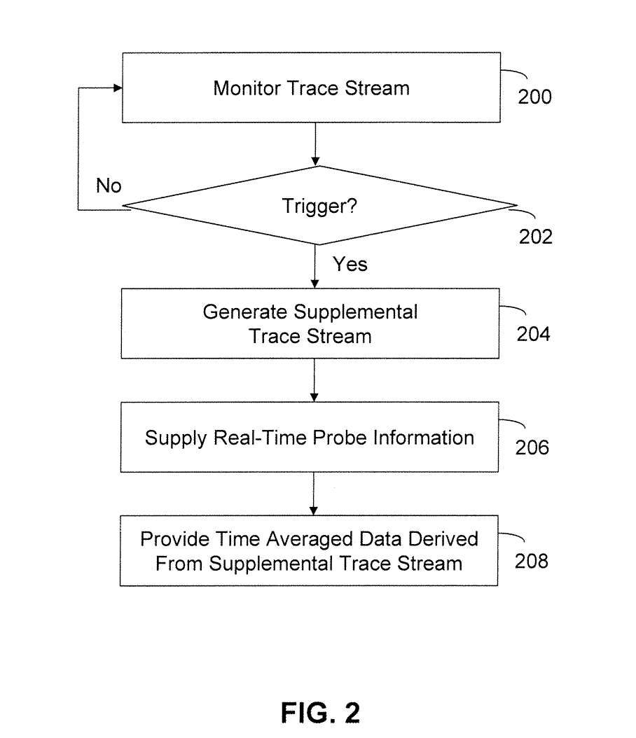

FIG. 2 illustrates processing associated with an embodiment of the invention, A free-running trace stream is monitored 200. The real-time decoder 128 may be used to implement this operation. It is then determined whether a trigger event exists in the free-running trace stream 202. For example, the real-time decoder 128 may be configured to identify PDTrace overflow (IO==0) or PDTrace backstall (IO==1). The trigger may also be in the form of an overwriting of the trace memory. If a trigger is identified, a supplemental trace stream is generated 204. That is, in addition to the trace stream that is applied to the trace storage controller 124 and the trace memory 126, a free-running supplemental trace stream is processed by the real-time decoder 128. While the trace stream that is applied to the trace storage controller 124 may be incomplete (e.g. overwritten), the free-running supplemental trace stream provides complete trace information, even in the event of a trace buffer overflow. Thus, the invention may be successfully exploited in connection with the evaluation of long-running operations.

Real-time probe information is then supplied 206. For example, the real-time decoder 128 may apply information to the real-time event indicator to provide a real-time indication of a processor execution state. This allows a user to actively monitor processor execution in connection with an event of interest (e.g., cache or pipeline utilization).

Time averaged data derived from the supplemental trace stream may also be provided 208. This may be implemented using the debug host 106, which stores and processes real-time content 140.

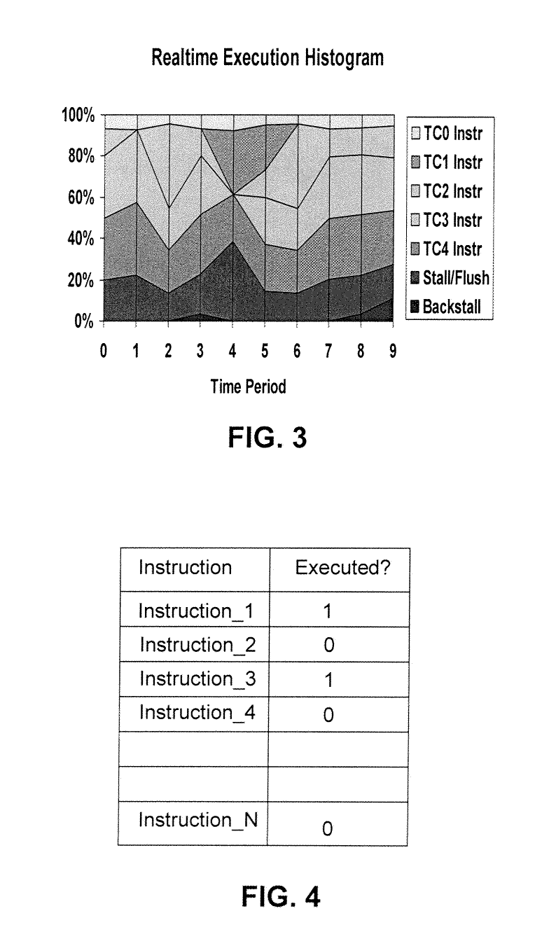

FIG. 3 provides an example of time averaged data derived from a supplemental trace stream. FIG. 3 illustrates a histogram displaying processor execution events, such as various instructions, stalls and backstalls as a function of time. At any given time, one can assess processor bandwidth associated with a given execution event. Additional events, such as pipeline utilization and cache utilization may also be tracked in accordance with embodiments of the invention.

The techniques of the invention may be used to confirm instruction execution in a running program, sometimes referred to as code execution coverage. Some types of mandated software testing, such as is required by the FAA for flight software, requires that a test be run on the actual code that is to be used in a final product, not a version modified with instrumentation points. The invention allows for such testing without instrumenting the software. As shown in FIG. 4, a simple code coverage table may be constructed to specify various instructions (Instruction_1 through Instruction_N) and whether the instruction has executed (e.g., a digital 1 means yes, a digital 0 means no). To obtain the code execution coverage table, PDTrace's “full pc on branch” is enabled to allow dynamic non-intrusive reconstruction of the addresses of completed instructions. These addresses (or shifted/masked/offset versions thereof) are then used to index into the code coverage table and update the status of the corresponding instruction from “not executed” to “executed”. The result is the code coverage table of all program instructions and an indication of whether each of the plurality of instructions has been executed. Similarly, a data coverage table could be generated by enabling load/store address capture in PDTrace and real-time detection and accumulation of data access information.

To reduce access bandwidth requirements to the code coverage table, one embodiment of the invention merges access to the code coverage table. For example, a system may provide more than one bit of memory that is allocated for storage of the executed status. In mixed MIPS16e and MIPS32 code, two bits of memory might be used per MIPS32 instruction. To avoid read/modify/write access to the code/data coverage table, an entire byte of memory may be allocated to store the same information. An implementation might have restrictions on the granularity of tracked access or separate tables for read and write access.

The invention may also be used to track hardware thread contexts in a multi-threaded system, such as the MIPS 34K processor. For example, the invention may be used to identify what proportion of instructions are executed in each of the thread contexts over a long period of time (i.e., longer than the trace buffer depth can capture).

The invention may also be used to filter what information is recorded in the trace buffer in order to reduce trace buffer memory requirements. For example, a user might only be interested in tracking function call and return rather than individual instruction execution. To do this, PDTrace output could be filtered by the real-time trace decoder to extract just the trace frames necessary to track those events and then re-encode the filtered frames for recordation in trace memory.

The invention may also be used for performance analysis. For example, the invention may be configured to track the elapsed time between certain specified pairs of events, such as the beginning and end of a function. The decoder detects these events and accumulates statistics regarding the function execution, such as the number of times the function was called and the minimum, average, and maximum elapsed time required to execute the function.

Thus, the invention includes a probe with a real-time decoder to dynamically detect a trigger in a free-running trace stream. In the event of such a trigger, the free-running trace stream can be processed to continue to provide meaningful real-time information, such as by utilizing the real-time event indicator to flag selected processor events. In addition, the real-time information may be logged for future processing, such as to provide time averaged data on real-time processor execution.

Thus, the invention provides real-time trace information at an external probe. That is, the probe does not simply log trace information for later analysis, although logging is also supported by the invention. The invention is not directed toward the trace port itself or the format of the information on the trace port, but rather the external processing system that extracts useful information from the trace stream and presents it to the user as the system runs. Some of the prerequisites for this type of analysis include trace information sent off-chip, rather than being collected on-chip. For execution profiling or code coverage, the off-chip trace must include full information about execution, not just branches. Ordinarily, PDTrace compresses the PC address and does not indicate certain types of branches at all (e.g., unconditional branches with a known destination address). However, PDTrace has the ability to transmit the PC address for all branches, thus allowing external hardware to track execution without referring to the program memory image.

The invention identifies when a probe disrupts system behavior due to a back-stall. The logic filters the trace stream and provides real-time analysis, such as logging extracted information or counting. The invention provides real-time decompression of the trace stream and looks for certain events, such as stall, cache miss, or a certain information addresses, which are then logged to a separate buffer.

Advantageously, the invention has no effect on processor behavior. One can switch on the trace and capture the part of the code one is interested in without side effects on the application.

The invention provides system on a chip design and verification flow. Thus, multiple core optimization and performance analyses may be achieved in accordance with embodiments of the invention.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). The software can also be disposed as a computer data signal embodied in a computer usable (e.g., readable) transmission medium (e.g., carrier wave or any other medium including digital, optical, or analog-based medium). Embodiments of the present invention may include methods of providing the apparatus described herein by providing software describing the apparatus and subsequently transmitting the software as a computer data signal over a communication network including the Internet and intranets.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A system, comprising:
a processor to generate a free-running trace stream; and
a probe with a real-time decoder to dynamically detect a trigger included in the free-running trace stream.

2. The system of claim 1 wherein the real-time decoder identifies a selected execution state within the processor.

3. The system of claim 2 further comprising an indicator on the probe to provide a real-time indication of the selected execution state.

4. The system of claim 3 wherein the indicator provides a real-time indication of an execution state selected from stall, back-stall, flush, and execution.

5. The system of claim 3 wherein the indicator provides a real-time indication of high trace bandwidth code.

6. The system of claim 3 wherein the indicator provides a real-time indication of pipeline utilization.

7. The system of claim 7 wherein the indicator provides a real-time indication of cache utilization.

8. The system of claim 1 further comprising a debug host to provide time averaged data on real-time processor execution state.

9. A probe, comprising:
trace memory;
a real-time decoder to generate a supplemental trace stream in response to a trace stream overwriting the trace memory; and
an indictor responsive to the supplemental trace stream to provide a real-time indication of an execution state within a processor.

10. The probe of claim 9 wherein the indicator provides a real-time indication of high trace bandwidth code.

11. The probe of claim 9 wherein the indicator provides a real-time indication of pipeline utilization.

12. The probe of claim 9 wherein the indicator provides a real-time indication of cache utilization.

13. The probe of claim 9 wherein the real-time decoder includes a frame extractor to identify frame borders.

14. The probe of claim 9 wherein the real-time decoder includes a content expander to identify events associated with a frame.

15. A method, comprising:
monitoring a trace stream from a processor;
generating a supplemental trace stream in response to a specified condition; and
activating a real-time event indicator in response to a selected processor event evidenced in the supplemental trace stream.

16. The method of claim 15 wherein the selected processor event is selected from stall, back-stall, flush, and execution.

17. The method of claim 15 wherein the selected processor event is high trace bandwidth code.

18. The method of claim 15 wherein the selected processor event is pipeline utilization.

19. The method of claim 15 wherein the selected processor event is cache utilization.

20. The method of claim 15 further comprising providing time averaged data on real-time processor execution state.

21. The method of claim 15 further comprising providing code execution coverage information.

22. The method of claim 15 further comprising providing hardware thread context information.

23. The method of claim 15 further comprising filtering the trace stream to produce filtered trace stream information for storage in a trace buffer.

24. The method of claim 15 further comprising providing performance analysis information.

25. A computer readable storage medium, comprising executable instructions to specify:
a probe including:
a real-time decoder to dynamically detect a trigger included in a free-running trace stream generated by a processor, and
an event indicator to provide a real-time indication of an execution state within the processor.

26. The computer readable storage medium of claim 25 further comprising executable instructions to specify a Joint Test Access Group (JTAG) controller.

27. The computer readable storage medium of claim 25 wherein the executable instructions to specify a real-time decoder include executable instructions to specify a frame extractor to identify frame borders in the free-running trace stream.

28. The computer readable storage medium of claim 25 wherein the executable instructions to specify a real-time decoder include executable instructions to specify a content expander to identify events associated with a frame in the free-running trace stream.
